(19) United States
(12) Patent Application Publication
(10) Pub. No.: US 2019/0200802 A1
(43) Pub. Date: Jul. 4, 2019

(54) Automatic Beverage Maker Reservoir with Drain

(71) Applicant: NuWave LLC, Libertyville, IL (US)

(72) Inventors: Jung S. Moon, Long Grove, IL (US); Jian Jiang Liu, Jiangmen City (CN)

(21) Appl. No.: 16/296,519

(22) Filed: Mar. 8, 2019

Related U.S. Application Data
(63) Continuation-in-part of application No. 15/916,818, filed on Mar. 9, 2018.
Application No. 15/916,818 is a continuation-in-part of application No. 15/867,012, filed on Jan. 10, 2018.
(60) Provisional application No. 62/444,453, filed on Jan. 10, 2017.

(51) Int. Cl. A47J 31/46; A47J 31/40; A47J 31/54; A47J 31/52; B08B 9/08

(52) U.S. Cl. CPC A47J 31/461; A47J 31/407; B08B 9/08; A47J 31/54; A47J 31/52; A47J 31/465

(57) ABSTRACT

An automatic beverage maker having a finable reservoir for holding water, a housing supporting the reservoir and having a base, a body and a pod section, a sealed water tank within the housing body, a heating element for heating water contained within the water tank, a first water line connecting the reservoir to the water tank inlet, a second water line connecting the water outlet to the cavity of the housing pod section, a water pump for moving water from the reservoir to the tank via the first water line and from the tank to the cavity of the housing pod section via the second water line, and a drain line fluidly coupled to the sealed tank and having an open end for discharging water from the sealed water tank.

### RELATED APPLICATIONS

The present application is a continuation-in-part of, and claims priority to U.S. patent application Ser. No. 15/916,818, titled “Automatic Beverage Maker” filed on Mar. 9, 2018, which is a continuation-in-part of U.S. patent application Ser. No. 15/867,012, titled “Automatic Beverage Maker” filed Jan. 10, 2018. The '818 and '012 applications are incorporated herein by reference in their entirety.

### TECHNICAL FIELD OF THE INVENTION

The present invention relates to automatic beverage makers. More specifically, the invention relates to a drain system for an automatic beverage maker.

### BACKGROUND OF THE INVENTION

Coffee has become an essential part of modern life. Some people can hardly function without their morning brew. Single-serving coffee makers (aka, pod brews) are popular home coffee makers because they can brew single cups of gourmet coffee in just a few seconds. But in order to keep the coffee tasting great, it is important to clean the machine from time to time, including the hot and cold water reservoirs.

In fact, studies show that routine cleaning will help ensure great-tasting coffee, coffee maker performance, and a germ-free machine. Conversely, an unclean coffee maker can harbor mold and other potentially harmful germs. The National Sanitation Foundation found that kitchen items, including coffee maker reservoirs, typically have higher germ counts than a bathroom door knob or light switch. Unfortunately, while the cold-water reservoir is easily removed, frequently drained, and often dishwasher safe, the hot-water reservoir is a fixed, sealed tank which often remains at least partly filled with water. This makes a thorough cleaning of the latter reservoir difficult with considerable uncertainty as to the cleaning effectiveness.

Until the invention of the present application, these and other problems in the prior art went either unnoticed or unsolved by those skilled in the art. The present invention provides a drainable hot-water tank for a beverage maker which provides greater certainty as to cleanliness without sacrificing design, style or affordability.

### SUMMARY OF THE INVENTION

There is disclosed herein an improved beverage maker which avoids the disadvantages of prior devices while affording additional structural and operating advantages.

Generally speaking, the automatic beverage maker comprises a fillable reservoir for holding water, a housing supporting the reservoir and having a base, a body and a pod section, a sealed water tank within the housing body, a heating element for heating water contained within the water tank, a first water line connecting the finable reservoir to the water tank inlet, a second water line connecting the water outlet to the cavity of the housing pod section, a water pump for moving water from the reservoir to the tank via the first water line and from the tank to the cavity of the housing pod section via the second water line, and a drain line fluidly coupled to the sealed tank and having an open end for discharging water from the sealed water tank.

Preferably, in a specific embodiment of the automatic beverage maker, the sealed tank further comprises an air inlet, positioned proximate the top of the tank, to facilitate draining of the tank. The air inlet includes a line having an open end extending through the housing to ambient air. Preferably, the air inlet line is closable with a valve cover

Further, a method for facilitating cleaning of the sealed water tank positioned within a housing of a beverage maker is also set forth. The tank includes a water inlet, coupled to a water reservoir via a first water line, and a water outlet, coupled to a pod cavity via a second water line. Generally speaking, the method comprises the steps of connecting a drain line to the sealed container within the housing, connecting an air line to the sealed container within the housing, providing a valve cover outside of the housing to close both the air line and the drain line, and removing the valve cover to allow water to drain from the sealed container through the drain line and air to enter the sealed container via the air line.

In a specific method, the sealed water tank may be flushed with a cleaning solution. The flushing stem preferably comprises the steps of filling the water reservoir with a suitable cleaning solution, operating the beverage maker to allow cleaning solution to flow from the reservoir into the sealed tank, and draining cleaning solution from the sealed tank through the drain line.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic illustration of an embodiment of the disclosed beverage maker having a drainable internal water tank;

FIG. 2 is another schematic of the embodiment of FIG. 1 illustrating the removal of a drain valve cover.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

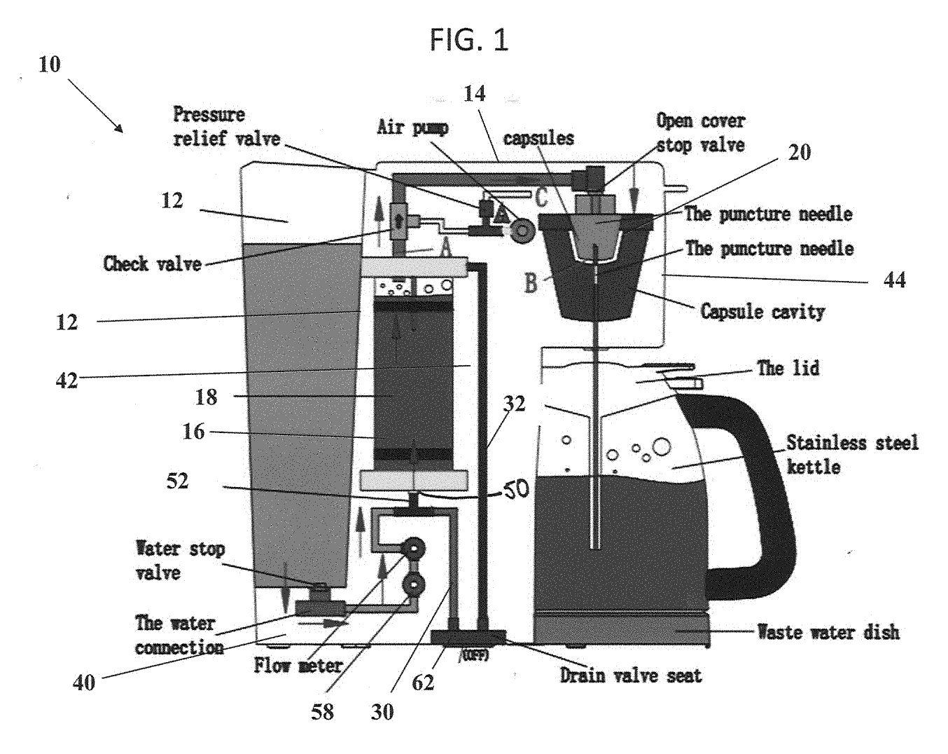

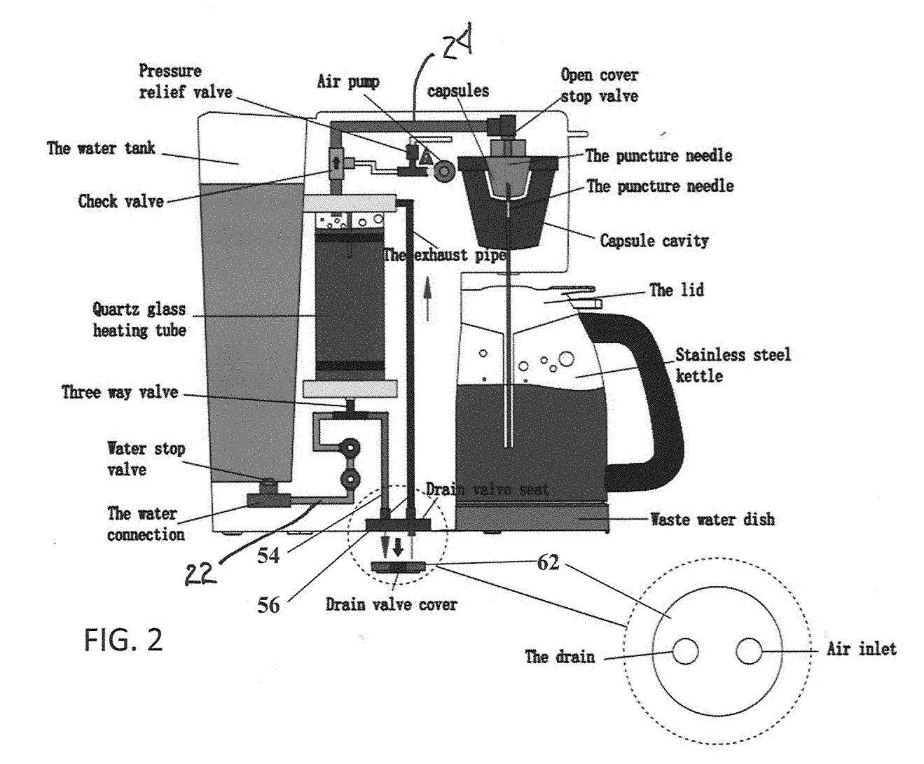

Referring to FIGS. 1-2, there is illustrated a beverage maker system, generally designated by the numeral 10. The particular illustrated beverage maker system 10 is for making hot beverages, such as tea and coffee. These systems are well-known in the art, utilizing sealed pods to produce single-servings of the hot beverages. The disclosed system is comprised of a water reservoir 12 attached to a housing 14 containing a sealed water tank 16, a heater 18 coupled to the water tank 16 to heat water within the tank, a pod cavity 20, and water lines 22 and 24 fluidly connecting these components to one another. Additionally, a drain line 30 and an air line 32 are connected to the sealed water tank 16.

The housing 14 is of typical plastic construction and includes a base 40, a body (or mid-section) 42 and a pod section 44. Most of the components of the system 10 are positioned within the body 42 of the housing 14. The reservoir 12 is typically detachable from an outer surface of the housing body 42. Within the pod section 44 is the pod cavity 20 where a beverage pod is positioned. The beverage pod may be for single-servings or for carafe-sized beverage production.

The sealed tank 16 typically maintains a volume of water within and the heater 18 keeps the volume of water warm while the system 10 is turned on. However, once the system 10 is turned off, the tank 16 may become a breeding ground for bacteria, molds, or the like. Accordingly, the ability to drain and properly flush the tank 16 on a regular basis helps maintain quality of the produced beverage.

The drain line 30 is preferably routed from a water inlet 50 for the water tank 16. A three-way valve 52 connected to the water inlet 50 is used to connect to both the first water line 22, which brings water to the tank 16 from the reservoir 12, and the tank drain line 30. While a separate water outlet may be created for the drain line 30, the use of the three-way valve 52 allows current beverage systems, which already have inlet lines, to be easily configured with a drain line without requiring modification to add a separate drain opening in the tank 16.

The air line 32 is preferably connected to the water tank 16 above the water line and allows air to flow into the tank 16 to replace water being drained from the tank. Both the air line 32 and the drain line 30 have ends 54 and 56 extending through the housing base 40 and opening at a bottom or side of the base 40. Preferably, a drain valve cover 62 attaches to both open ends, 54 and 56, to prevent drainage from tank 16. However, once the cover 62 is removed, water will drain from the tank 16 out the drain line 30 as air is pulled into the air line 32 until all water is removed from the tank 16. The drain valve cover 62 can then be replaced on the open ends 54 and 56.

Once all the water is removed, a cleaning cycle can be run to flush out the water tank 16. This can be accomplished by cycling through cleaning and rinsing steps, as needed. The cleaning step may require adding an appropriate cleaning solution to the reservoir 12, then turning the system 10 on to pump the solution into the water tank 16 via water pump 58. The draining procedure can then be used to remove the cleaning solution, as necessary. The rinsing step is similarly achieved using only water to flush through the water tank 16.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An automatic beverage maker comprising:
a fillable reservoir for containing water to make a beverage;
a housing supporting the reservoir and having a base, a body and a pod section, wherein the pod section comprises a cavity for placement of a beverage pod to be used in making a beverage and a delivery opening for dispensing the beverage into a container;
a sealed water tank within the housing body and having a water inlet and a water outlet;
a heating element contacting the sealed water tank for heating water contained within the water tank;
a first water line connecting the fillable reservoir to the water tank inlet;
a second water line connecting the water outlet to the cavity of the housing pod section;
a water pump for moving water from the reservoir to the tank via the first water line and from the tank to the cavity of the housing pod section via the second water line; and
a drain line fluidly coupled to the sealed tank and having an open end for discharging water from the sealed water tank.

2. The automatic beverage maker of claim 1, wherein the sealed tank further comprises an air inlet to facilitate draining of the tank.

3. The automatic beverage maker of claim 2, wherein the air inlet connects to the sealed tank proximate a top of the tank and the drain line connects to the sealed tank through the first water line.

4. The automatic beverage maker of claim 1, further comprising a drain line valve cover to prevent discharge of water from the sealed tank.

5. The automatic beverage maker of claim 4, further comprising an air inlet line valve cover.

6. The automatic beverage maker of claim 5, wherein the drain line valve cover and the air inlet valve cover comprise a single valve cover.

7. The automatic beverage maker of claim 1, wherein the first water line and the drain line connect to the water inlet via a three-way valve.

8. The automatic beverage maker of claim 6, wherein the drain line and the air inlet each have an open end in the housing base.

9. The automatic beverage maker of claim 1, further comprising a drain valve cover detachable from the housing base.

10. A method for facilitating cleaning of a sealed water tank positioned within a housing of a beverage maker, the tank having a water inlet, coupled to a water reservoir via a first water line, and a water outlet, coupled to a pod cavity via a second water line, the method comprising the steps of:
connecting a drain line to the sealed container within the housing;
connecting an air line to the sealed container within the housing;
providing a valve cover outside of the housing to close both the air line and the drain line; and
removing the valve cover to allow water to drain from the sealed container through the drain line and air to enter the sealed container via the air line.

10. method of claim 10, further comprising the step of flushing the sealed water tank with a cleaning solution.

12. The method of claim 10, wherein the valve cover attaches to both an open end of the air line and an open end of the drain line.

13. The method of claim 10, wherein the drain line is connected to the sealed tank via a three-way valve.

14. The method of claim 11, wherein the step of flushing the sealed tank with a cleaning solution comprises the steps of:
filling the water reservoir with a suitable cleaning solution;
operating the beverage maker to allow cleaning solution to flow from the reservoir into the sealed tank; and
draining cleaning solution from the sealed tank through the drain line.
